(19) United States
(12) Patent Application Publication
(10) Pub. No.: US 2011/0139379 A1
(43) Pub. Date: Jun. 16, 2011

(54) DOOR ASSEMBLY

(76) Inventors: Bryan P. Zacher, Brookings, SD (US); Bruce E. Thomas, Brookings, SD (US); Allen E. Lee, Brookings, SD (US)

(21) Appl. No.: 13/035,667

(22) Filed: Feb. 25, 2011

Related U.S. Application Data
(62) Division of application No. 11/706,072, filed on Feb. 14, 2007.
(60) Provisional application No. 60/773,077, filed on Feb. 14, 2006.

(51) Int. Cl. E06B 5/00; E06B 7/14; E06B 3/50

(52) U.S. Cl. 160/91; 49/408; 49/142

(57) ABSTRACT

A door assembly includes a door panel and a window assembly. The window assembly includes a first frame operably coupled to a second frame. A movable panel is operably coupled and selectively movable in a channel defined by a leg and a wall of the first frame and a leg of the second frame. A fixed panel and a window screen can also be operably coupled between the first frame and the second frame. At least one of the frames include a basin that empties into a drainage opening to prevent the build up of moisture within the assembly.

### RELATED APPLICATIONS

The present application is a divisional of U.S. application Ser. No. 11/706,072, filed Feb. 14, 2007, which claims the benefit of U.S. Provisional Patent Application No. 60/773,077 entitled “Door Assembly,” filed Feb. 14, 2006, which are hereby incorporated by reference in their entirety.

### FIELD OF THE INVENTION

The invention relates generally to a door assembly. More particularly, the invention relates to a storm door having a movable window panel operably received in a channel defined between inner and outer window frame members.

### BACKGROUND OF THE INVENTION

Entryways into residences and other structures often include a main, generally solid door and a storm door. Storm doors can be used to provide additional thermal and moisture resistance. In addition, storm doors incorporating screens can provide a barrier to insects and pests while enabling selective air circulation through the screen.

Conventional self-storing storm doors often include a fixed glass panel and a movable glass panel. Each panel generally occupies a portion of an opening defined within the storm door. The movable glass panel can be moved into a position generally offset with respect to the fixed glass panel (e.g., the movable panel can be above a lower relative fixed panel or below a higher relative fixed panel) such that the entire opening is covered by the combination of movable and fixed panels. Alternatively, the movable glass panel can be moved to a position partially or fully overlapping the fixed glass pane. This configuration enables air to circulate through the portion of the opening in the door panel vacated by and previously covered by the sliding glass pane.

In conventional storm doors having screens, spring-loaded latches or inserts included on the movable panels can be locked into a plurality of vertical positions along the opening in the door panel to expose varying degrees of the screen. This enables a user to select the level of ventilation permitted by the storm door, i.e., the sliding glass panel can be partially opened or closed as intermediate temperature conditions dictate.

Given the acceptance of self-storing storm doors in the market place, improvements to the design, manufacturability and ease of installation and use would be welcome.

### SUMMARY OF THE INVENTION

The various door and window assemblies disclosed herein provide for moveable and/or fixed panel configurations in a readily manufactured assembly that is easy to install and use. In certain embodiments of the invention, a panel is mounted between two frames members, for example front and rear portions of a two-piece frame assembly. The two frames combine to define a channel that receives the panel. The front and rear portions may each be unitary, integrally formed components. In other embodiments, the front and rear portions can be multi-piece components. For example, each portion can include four linear members coupled together with corner locks or frame connector members to form four-sided front and rear portions. The fixed panel can also be generally fixed or captured at the edges within a pan in the frame assembly defined in or between interior and exterior frame members.

The movable panel can be movable within the channel defined by a flange or leg and a sidewall or back of the interior frame and a flange or leg in the exterior frame. Alternatively, the movable panel can be movable within the channel defined by a flange or leg and a sidewall or back of the exterior frame and a flange or leg in the interior frame. The channel can extend the entire length of the frame assembly, thus enabling the movable panel to be operated between fully opened and fully closed positions, and any intermediate positions therebetween. The movable panel may be guided by pins or latches attendant the operation of the movable panel that protrude from the periphery of the movable panel. The panel may also be guided by bearing surfaces at or near the perimeter of movable panel that slidingly engage channel.

An advantage of certain embodiments of the invention is that the window assembly can be easily assembled, in part because the movable panel is mounted within a channel defined by two or more portions of a frame assembly.

An additional advantage of certain embodiments of the invention is that the frame assembly can include discharge or weep ports in a portion of the frame assembly for rain or moisture to escape through to inhibit moisture damage to the door and window assembly. The weep ports can also inhibit water or moisture from building up in the door or window assembly. The assembly may further include a basin connected to or integrally formed with the frame assembly that catches and directs water to the discharge ports. The discharge or weep ports can be integrally molded in the frame and can have an exit portion thereof on a front or bottom portion of the window frame.

Another advantage some embodiments of the invention is that the movable panel can be locked or latched at different heights within the frame assembly, such that the window can be closed, partially open, or fully open. The movable panel may also be positioned without the use of latches.

### BRIEF DESCRIPTION OF THE FIGURES

FIG. 1 is an exploded perspective view of a door assembly according to an embodiment of the invention;

FIG. 2 is a front elevational view of the door assembly of FIG. 1;

FIG. 3 is a rear elevational view of the door assembly of FIG. 1;

FIG. 4 is a partial cross-sectional view taken along line 4-4 of FIG. 2;

FIG. 5 is a partial cross-sectional view taken along line 5-5 of FIG. 2;

FIG. 6 is a partial cross-sectional view taken along line 6-6 of FIG. 2;

FIG. 7 is a partial cross-sectional view taken along line 7-7 of FIG. 2;

FIG. 8 is a partial cross-sectional view taken along line 8-8 of FIG. 2;

FIG. 9 is an enlarged sectional view of a door assembly according to a second embodiment of the invention depicting a discharge port exiting from a bottom of the exterior frame member;

FIG. 10 is an enlarged, partial perspective view of the door assembly of FIG. 9;

FIG. 11 is an enlarged, partial perspective view of a top of a frame in a third embodiment of the invention;

FIG. 12 is an enlarged, partial perspective view of a fixed frame and a movable frame of a window assembly in a fourth embodiment of the invention;

FIG. 13 is an enlarged, partial perspective view of a movable frame operatively coupled to a window assembly in the embodiment of FIG. 12;

FIG. 14 is an enlarged, partial perspective view of a bottom portion of a frame assembly in a fifth embodiment of the invention;

FIG. 15 is a partial perspective view of a frame assembly in a sixth embodiment of the invention;

FIG. 16 is an enlarged, partial, exploded perspective view of a corner of the door assembly in a seventh embodiment of the invention;

FIG. 17 is a partial, enlarged assembled view of a corner of the door assembly of FIG. 16;

FIG. 18 is a partial cross-sectional view of the assembly of FIG. 17;

FIG. 19 is a cross-sectional view of a portion of a side of a window assembly with partial view of a panel in an eighth embodiment of the invention;

FIG. 20 is a cross-sectional view of a portion of a side of a window assembly with partial view of a panel in a ninth embodiment of the invention;

FIG. 21 is a cross-sectional view of a portion of a side of a window assembly with partial view of a panel in a tenth embodiment of the invention; and

FIG. 22 is a cross-sectional view of a portion of a side of a window assembly with partial view of a panel in an eleventh embodiment of the invention.

### DETAILED DESCRIPTION

References to relative terms such as upper and lower, front and back, interior and exterior, left and right, or the like, are intended for convenience of description and are not contemplated to limit the invention, or its components, to any specific orientation. All dimensions depicted in the figures may vary with a potential design and the intended use of a specific embodiment of this invention without departing from the scope thereof.

Each of the additional figures and methods disclosed herein may be used separately, or in conjunction with other features and methods, to provide improved systems and methods for making and using the same. Therefore, combinations of features and methods disclosed herein may not be necessary to practice the invention in its broadest sense and are instead disclosed merely to particularly describe representative embodiments of the invention.

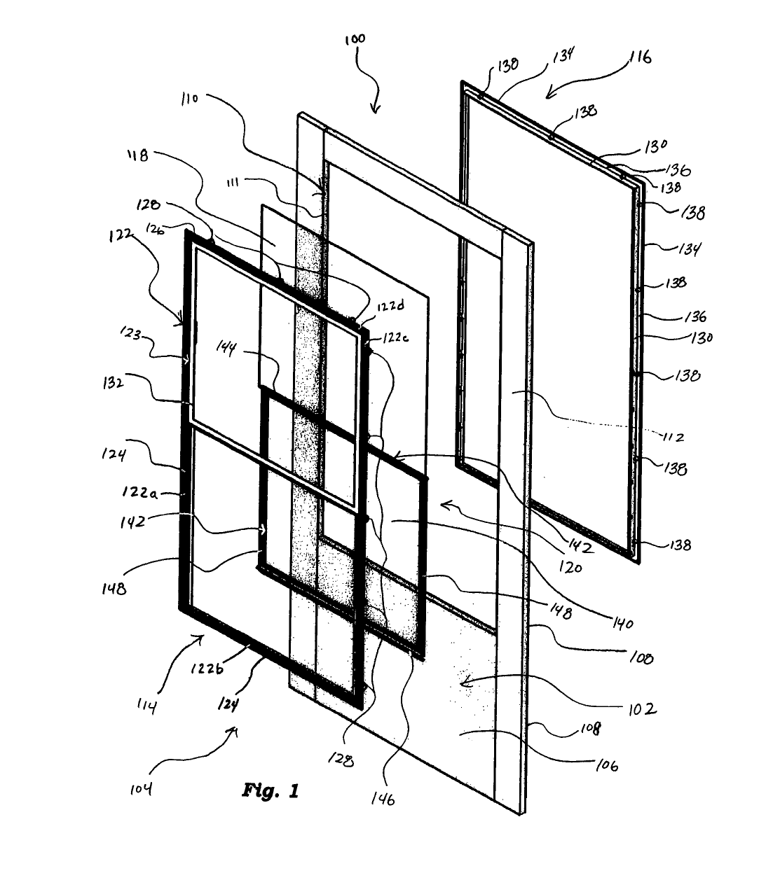

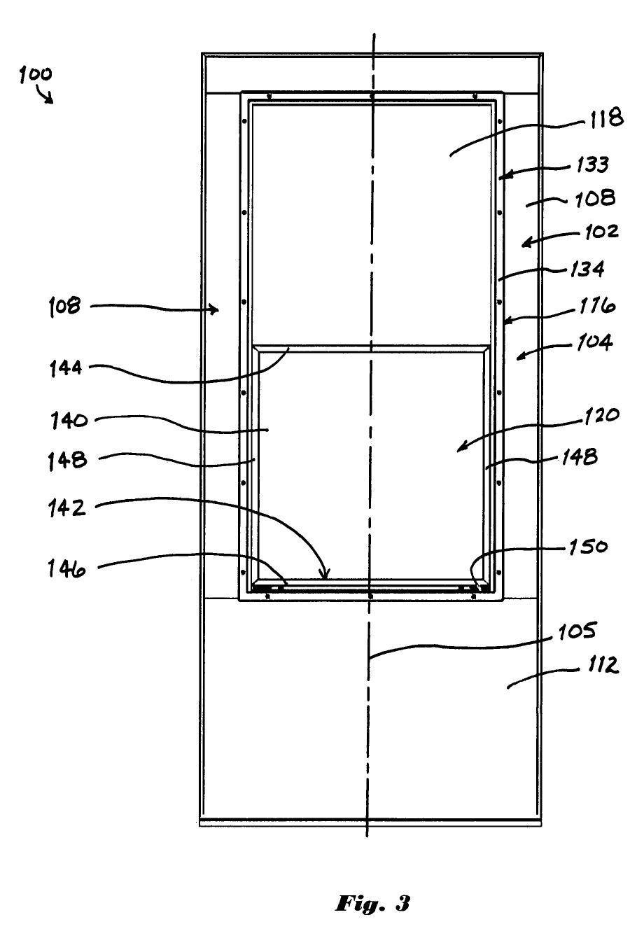

Referring to FIGS. 1 through 3, a storm door assembly 100 broadly includes a panel such as a door panel 102 and a window assembly 104 operably integrated therein. The door panel 102 and window assembly 104 may be substantially symmetric about a vertical centerline 105. The door panel 102 generally includes an exterior surface 106, a generally opposed interior surface 108, and an opening 110 defined on the exterior and interior surfaces 106, 108 and extending therebetween. While the opening 110 is depicted as being generally rectangular in shape, those skilled in the art will recognize that other shapes can be used without departing from the scope and spirit of the invention.

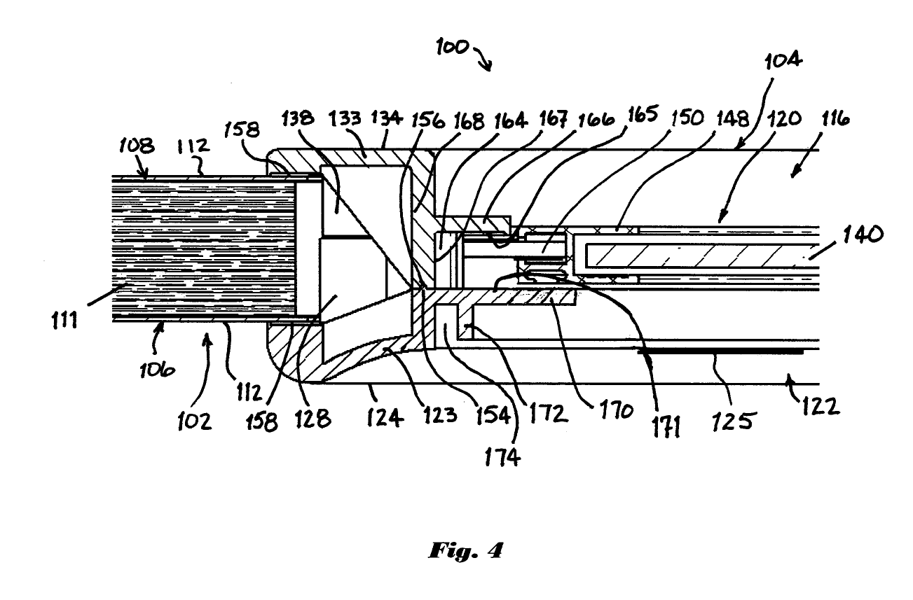

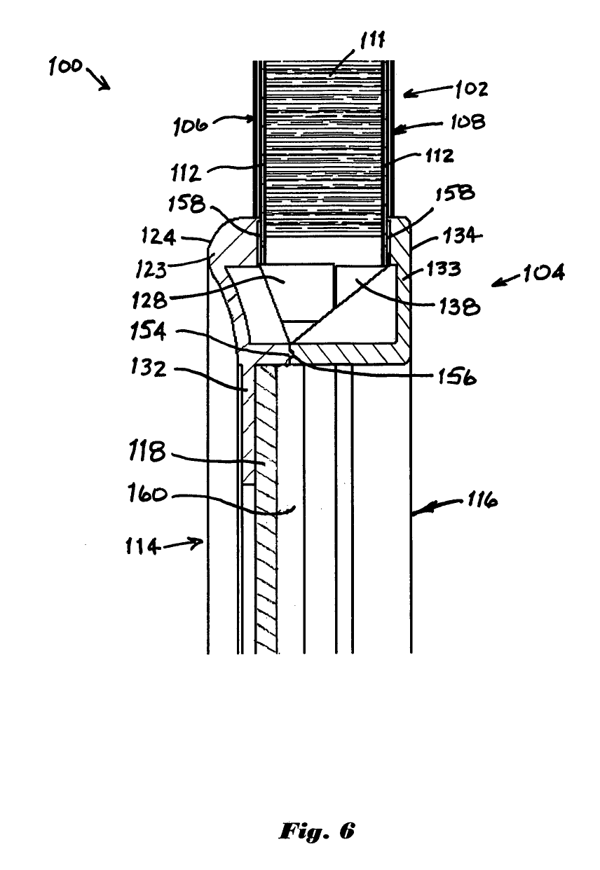

Referring to FIGS. 4-6 and 8, the door panel 102 may include a core 111 and a laminate or cladding 112 operably coupled to the core 111 to form each of the exterior and interior surfaces 106, 108. In other embodiments, the door panel 102 may not include the cladding 112 so that the exterior and interior surfaces 106, 108 are defined by the material that forms the core 111. In one embodiment, the core 111 may be constructed of wood-products (as depicted) and the cladding 112 may be of a metal, such as aluminum, or a cured resin, such as vinyl. Those skilled in the art will recognize that the core 111 can be constructed of, for example, any metal, plastic, composite, or any combination thereof without departing from the scope and spirit of the invention.

Referring again to FIG. 1, the window assembly 104 generally includes an exterior frame assembly 114 and an interior frame 116 with a fixed glass panel 118 and a movable panel 120 operably coupled therebetween. When assembled, the movable panel 120 can generally be coupled in a channel defined by the exterior frame assembly 114 and interior frame 116 and can be selectively movable between open and closed configurations. The channel is described in further detail below with respect to FIG. 4. While the fixed panel 118 is depicted as being generally transparent, the fixed panel 118 can be generally translucent or generally opaque without departing from the scope and spirit of the invention. The fixed panel 118 may be constructed of a glass or a polymer such as polymethylmethacrilate, sold under the trademark PLEXIGLAS.

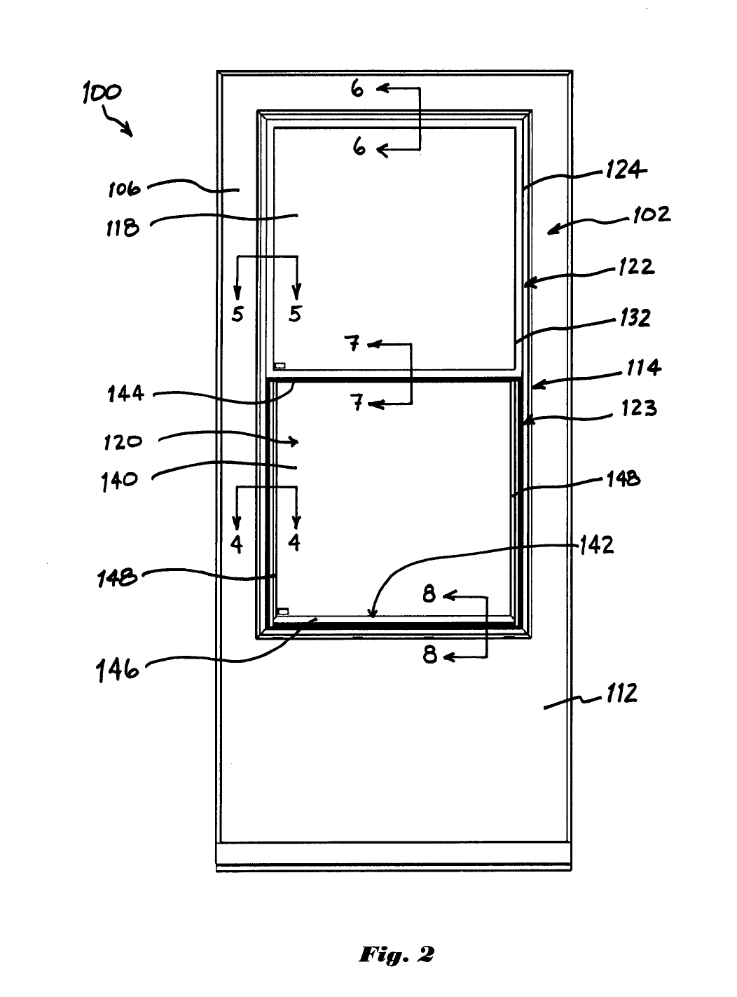

The exterior frame assembly 114 generally includes an exterior frame 122 including an outwardly extending flange 123 presenting an exterior face 124 and a generally opposed inner portion 126 including a plurality of mounting bosses 128 defined thereon or operably coupled thereto (FIGS. 1 and 2). The exterior frame 122 may be a unitary or integrally formed component, or alternatively, a multi-piece component. For example, the exterior frame 122 may be comprised of independent frame members e.g., four linear members 122a, 122b, 122c and 122d (FIG. 1), or two L-shaped members (not depicted) coupled together with frame connector members to form the exterior frame 122.

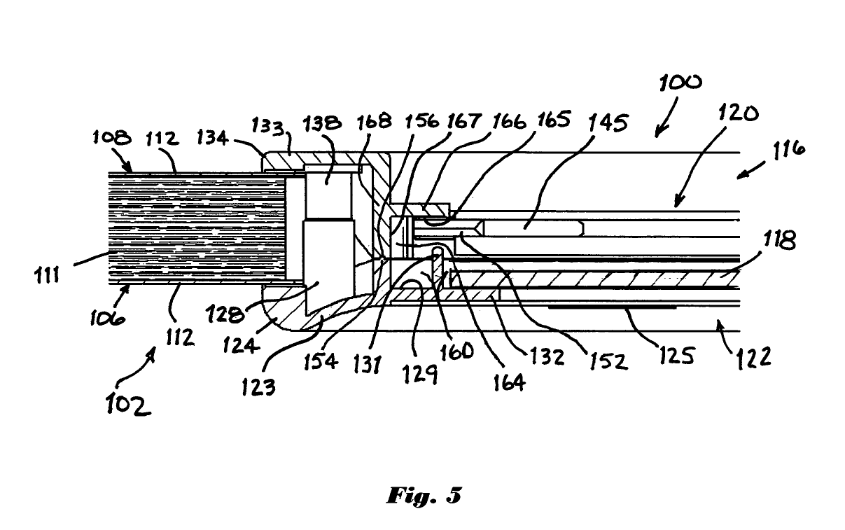

The exterior frame 122 further generally includes a fixed panel frame 132 having an interior facing surface 129, the panel frame 132 being coupled to an upper portion of the exterior frame 122 for operably framing the fixed panel 118 between the exterior frame assembly 114 and interior frame 116. The panel frame 132 may also include a rib portion 131 that extends from the interior surface 129 (FIG. 5). While the exterior frame 122 can be formed using a molding process, those skilled in the art will recognize that other forming processes, such as pultruding and extruding, can be used to construct the exterior frame 122 without departing from the scope and spirit of the invention. The exterior frame 122 can be formed of a thermoset or thermoplastic resin. The exterior frame 122 can alternatively be die cast with metal, such as an aluminum-zinc alloy.

The interior frame 116 includes an inner flange 133 presenting an interior face 134 and a generally opposed inner portion 136 including a plurality of interior frame mounting bosses 138 defined thereon that cooperate with the plurality of exterior frame mounting bosses 128 for operably coupling the interior frame 116 to the exterior frame 122. The interior frame 116 can be a unitary, integrally formed component. Alternatively, the interior frame 116 can be a multi-piece component. As with the exterior frame 122, the interior frame 116 may be constructed of independent members coupled together with frame connector members (not depicted). The interior frame 116 may further include a window assembly jamb 130 for operably coupling the interior frame 116 with the opening 110 defined on the door panel 102.

The interior frame 116 may be formed in a molding process, or by pultrusion or extrusion, or by other processes known to the artisan without departing from the scope and sprit of the invention. The interior frame 116 may be formed of a thermoset or thermoplastic resin, or it may be die cast with metal, such as an aluminum-zinc alloy, or formed from wood or other materials available to the artisan. The diameter of the bosses 128, 138 may be of a diameter that accommodates standard sized ejector pins (e.g. 0.313-in. diameter) for assembly.

The movable panel 120 generally includes a pane 140, a movable panel frame 142 including a top 144, a generally opposed bottom 146, and a pair of generally opposed sides 148. The bottom 146 can include a latch 150 for operably securing the movable panel at a selected height within the window assembly 104, as depicted in FIG. 4. The top 144 can include a channel or tilt pin 152 for operably guiding the movable panel 120 within a movable panel channel 164 included in the exterior and interior frames 122, 116, as best seen in FIG. 5. The movable panel channel 164 may extend along opposing sides of the window assembly 104, or the channel 164 may be continuous along three or four sides of the window assembly 104. The channel pin 152 can extend off of a corner lock 145, which can be a molded or cast plug used to couple portions (top 144, bottom 146, and sides 148) of the movable panel frame 142.

In other embodiments, the movable panel 120 can be retractable without any latches. U.S. Pat. No. 6,618,998 entitled “Door with Variable Length Screen,” hereby incorporated by reference in its entirety, depicts and describes a movable panel that can be positioned without the use of latches. In this embodiment, the movable panel frame 142 may be operably guided by sliding contact with surfaces of the movable panel channel 164 rather than by sliding contact with pins or latches.

Cross-sectional views of the door assembly 100 are depicted in FIGS. 4-8, portraying the interrelation of the door assembly 100 components is further depicted. When the plurality of mounting bosses 128, 138 on the exterior and interior frames 122, 116 are pressed or otherwise coupled together, the exterior frame mounting bosses 128 operably engage the plurality of interior frame mounting bosses 138 on the interior frame 116 to operably couple the exterior and interior frames 122, 116 together. Screws or other fasteners known to those skilled in the art can be inserted through bosses 128, 138 (or in lieu of the bosses 128, 138) to fix the exterior and interior frames 122, 116 together. Those skilled in the art will also recognize that such fasteners could include snap-together fasteners integrally formed with or operably coupled to the exterior and interior frames 122, 116. In addition, an adhesive could be used to fix the exterior and interior frames 122, 116 together.

As described above, the fixed and movable panels 118, 120 are operably coupled between the exterior and interior frames 122, 116. The proper alignment of exterior and interior frames 122, 116 can be facilitated by a tongue-in-groove design utilizing a lip 154 defined on and projecting from and running circumferentially around the exterior frame 122 and a corresponding recess 156 defined in and running circumferentially around the interior frame 116. When the exterior and interior frames 122, 116 are pressed or otherwise coupled together, the lip 154 and recess 156 enable the frames to properly align to one another. Those skilled in the art will recognize that the lip can alternatively be included on the interior frame 116 and the recess included on the exterior frame 122, opposite that as generally depicted in the figures.

As described above, the exterior frame 122 can include an outwardly extending flange 123 extending around its perimeter. Although depicted as having a generally curvilinear cross-section, the flange 123 may also be of generally linear cross-section. Likewise, the interior frame 116 can include a flange 133 around its perimeter. Although depicted as being generally linear, the cross-section of the flange 133 can also be generally curvilinear. The flanges 123, 133 on the exterior and interior frames 122, 116 can generally define a door channel 158 for receiving the exterior and interior surfaces 106, 108 of the door panel 102 when the exterior and interior frames 122, 116 are pressed together or otherwise coupled onto the door panel 102.

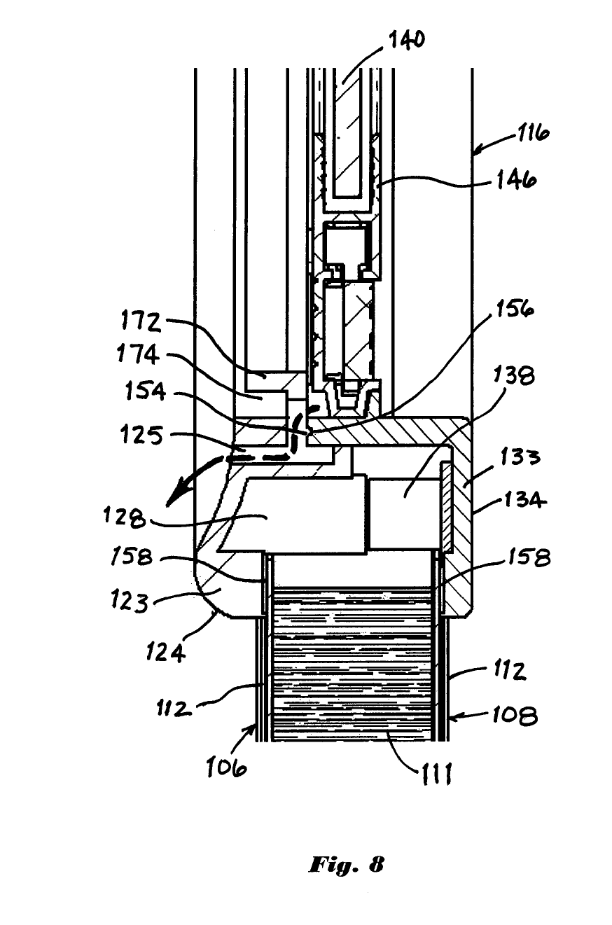

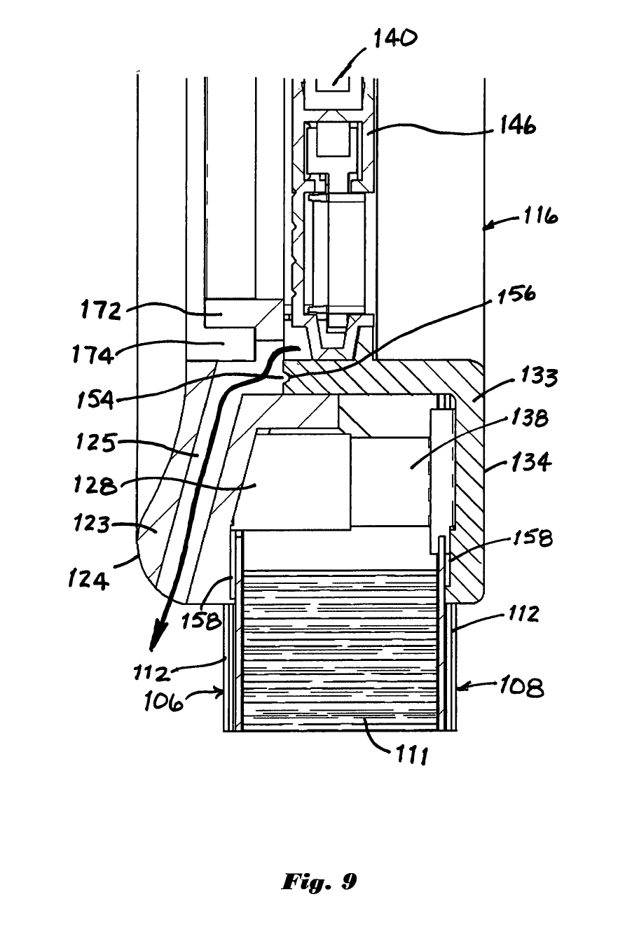

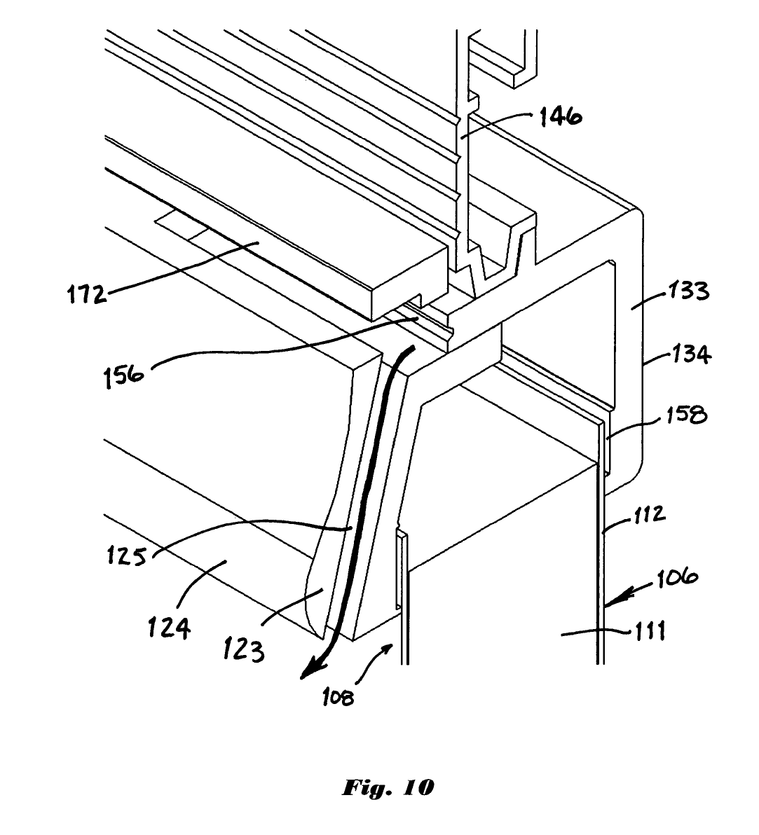

Referring to FIGS. 9 and 10 and again to FIG. 8, the exterior frame 122 can further include a drainage or weep port opening 125 formed in the outwardly extending flange 123. The drainage port 125 can extend from proximate the bottom 146 of the movable panel frame 142 through the outwardly extending flange 123 and exiting through the front of the exterior face 124. The broken line arrow in FIG. 8 depicts generally the exit path of water or moisture in the assembly. The drainage port 125 can alternatively exit through a lower or bottom portion of the exterior face 124 (FIGS. 9 and 10). The drainage ports 125 may also be formed with a plurality of gratings 127 that span the drainage passageway. The arrow generally depicts the exit path of water or moisture in the assembly.

The drainage port 125 enables rain or moisture to exit the window assembly 104. The configuration depicted in FIGS. 9 and 10 provide this functionality of having a discharge port while not affecting the aesthetics of the exterior face 124 because the port is on an underside of the exterior face 124. The gratings 127 may be sized to limit the size of insects that can enter the window assembly 104 through the drainage port 125. An exemplary and non-limiting dimension for spacing between the grating elements is on the order of 0.070-in.

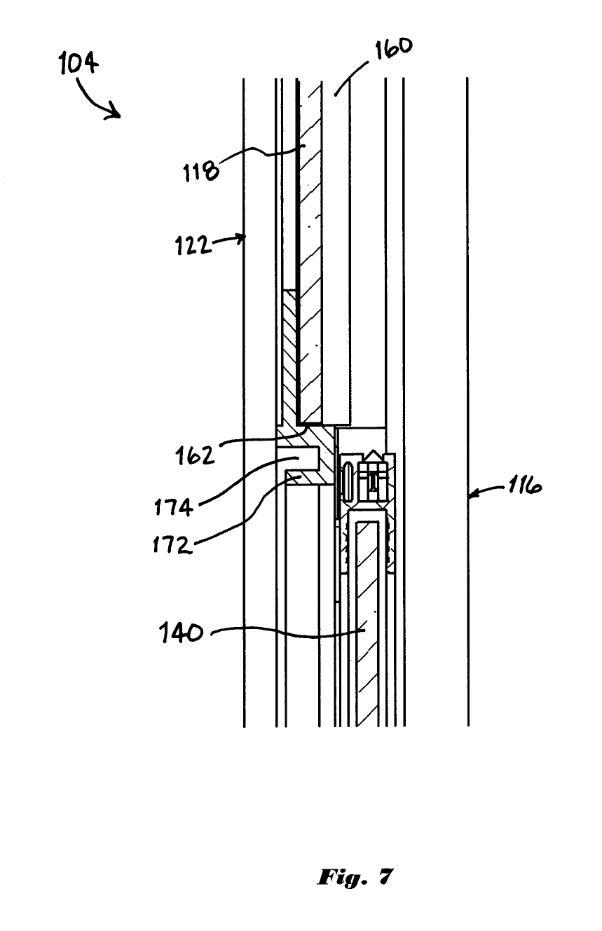

The fixed panel 118 can be coupled in a pan 160 that can be defined between and by the exterior and interior frames 122, 116 of the window assembly 104 (FIG. 7). The fixed panel 118 can rest on a ledge 162 that extends generally perpendicularly from exterior frame 122 between upper portion and lower portions of window assembly 104 such that the fixed panel 118 can be fixed within an upper portion of the window assembly 104.

The assemblies depicted herein portray window assemblies having a fixed panel 118 and a movable panel 120. Alternative embodiments (not depicted) may instead comprise two movable panels, two fixed panels, or a single fixed panel covering the combined length of the two panel arrangement.

Referring again to FIGS. 4 and 5, the movable panel 120 can be operably retained and movable within a movable panel channel 164 that can be defined by the exterior and interior frames 122, 116. On the lower portion of the window assembly 104, best depicted in FIG. 4, the movable panel channel 164 can be defined by an exterior facing surface 165 on a flange or leg 166 on the interior frame 116, an inward facing perimeter 167 on a sidewall or back 168 on the interior frame 116, and an interior facing surface 171 on a flange or leg 170 on the exterior frame 122. On the upper portion of the window assembly 104, the channel is defined by exterior facing surface 165 and inward facing perimeter 167 of the interior frame 122 in cooperation with the interior facing surface 129 of the fixed panel frame 132 (FIG. 5). When present, the rib portion 131 that extends from the interior surface 129 that guides the movable panel 120 by providing a bearing surface for the channel pin 152 to engage when the movable panel 120 is adjacent the fixed panel 118. The movable panel channel 164 can therefore be defined when the exterior frame 122 is operably coupled with the interior frame 116. The movable panel channel 164 can be generally continuous from proximate the top of the frames 122, 116 to the bottom of the frames 122, 116 and generally runs behind the fixed panel pan 160 in the window assembly 104 relative to the exterior and interior frames 122, 116. Those skilled in the art will recognize that the exterior frame 122 can include a back in addition to the leg, such that the channel is defined by a leg on the interior frame and a leg and back on the exterior frame.

As best seen in FIG. 4, the movable panel 120 can be held at different heights within the movable panel channel 164 by spring biased operable loaded latches 150 included on the bottom 146 of the movable panel frame 142. The latches 150 extend laterally outwardly into slots included on the jambs included in the window assembly 104 to lock the movable panel 120 insert into a plurality of spaced apart vertical positions to control the desired degree of openness in the opening. In other embodiments, the window assembly 104 can include a balance mechanism enabling the movable panel 120 to be held at different heights within the movable panel channel 164 without the use of latches.

In other embodiments, the window assembly 104 can include a retractable screen assembly, such as that described in U.S. Pat. No. 6,618,998 entitled “Door with Variable Length Screen,” incorporated by reference above.

When the latches 150 are pressed inwardly, the movable panel 120 can be moved upwardly and downwardly within the movable panel channel 164. When the latches 150 are released, they can lock against or relative to the sides 148 of the movable panel frame 142, thus suspending the movable panel 120 within the movable panel channel 164. The movable panel 120 can be movable from a fully closed position (i.e., completely covering a lower portion of the opening 110) to a fully open position (i.e., completely within an upper portion of the opening 110 overlapping the fixed panel 118) and any various positions therebetween. Alternatively, the movable panel 120 may assume a closed position in the upper portion of the movable panel frame. As such, different levels of ventilation can be achieved by moving the movable panel 120 within the movable panel channel 164. The movable panel 120 can further include a channel pin 152 that can guide a top portion of the movable panel 120 in the movable panel channel 164 (FIG. 5). One skilled in the art will recognize other ways by which the movable panel can be transposed and locked within the channel.

A window screen (not depicted) can also be disposed in an upper or lower portion of window assembly 104 such that insects and other pests are inhibited from entering while still enabling free air flow when movable panel 120 is in an open or partially open position. The Exterior frame 122 includes a flange 172 that defines a U-shaped channel 174 into which a screen can be removably inserted. The window screen can also be separate from the window assembly 104 and can be included in a separate screen frame (not depicted). In another embodiment, a screen may be anchored to the exterior frame 122 by securing the edges of the screen within the U-shaped channel 174 with a cord or other suitable packing material (not depicted).

In another embodiment, the window assembly of the door can include two or more movable panels. For example, the window assembly can include bottom and top movable panels.

Referring to FIG. 11, a window assembly 180 in another embodiment of the invention is illustrated. The fixed panel frame 132 includes a ridge 182 that is formed at or near the junction of the outwardly extending flange 123 and the fixed panel frame 132, the ridge 182 protruding inward from exterior frame 122. The interior frame 116 includes an L-shaped portion 184 that depends from therefrom and contacts or nearly contacts the fixed panel 118. The lip 154 extends from the interior frame 116 and mates with the recess 156 on the exterior frame 122 in this embodiment.

Functionally, the ridge 182 enables the fixed panel 118 to be reduced in size. The L-shaped portion 184 keeps the inside reveal of the fixed panel uniform about the interior periphery. The ridge 182 also provides for the recess 156 to be formed deeper and the lip 154 to be correspondingly longer, thereby providing for a more positive engagement between the interior and exterior frames 116, 122 and enhancing the structural integrity of the door assembly 180.

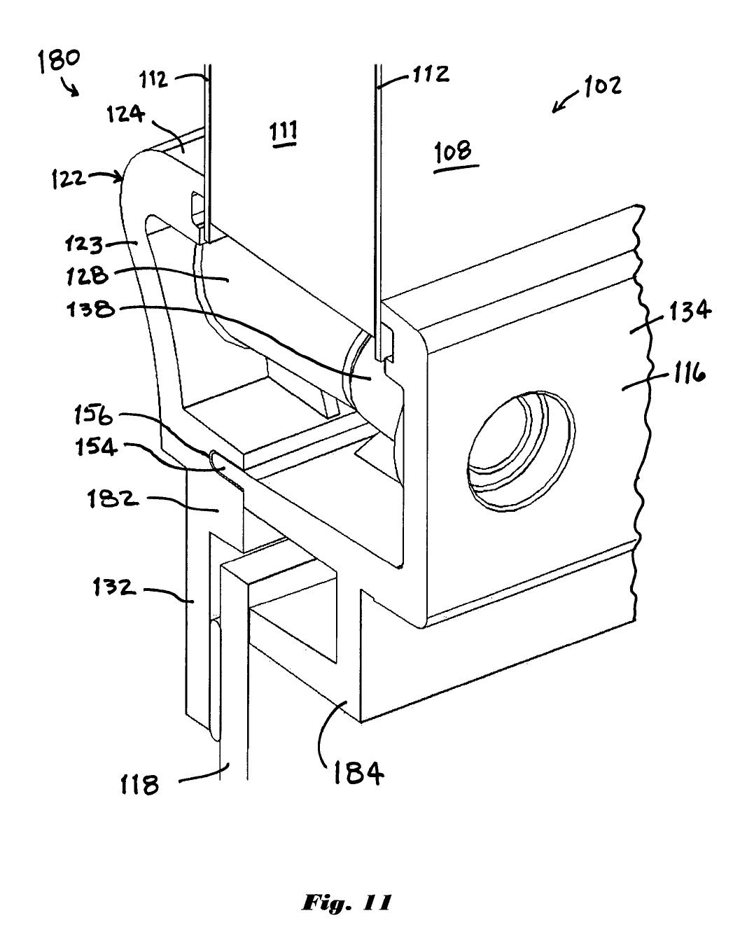

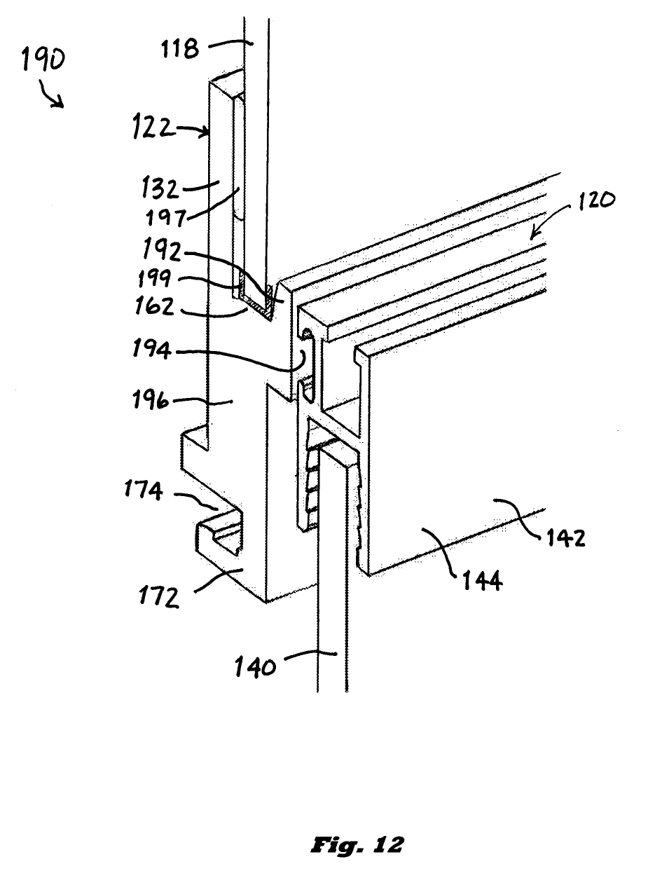

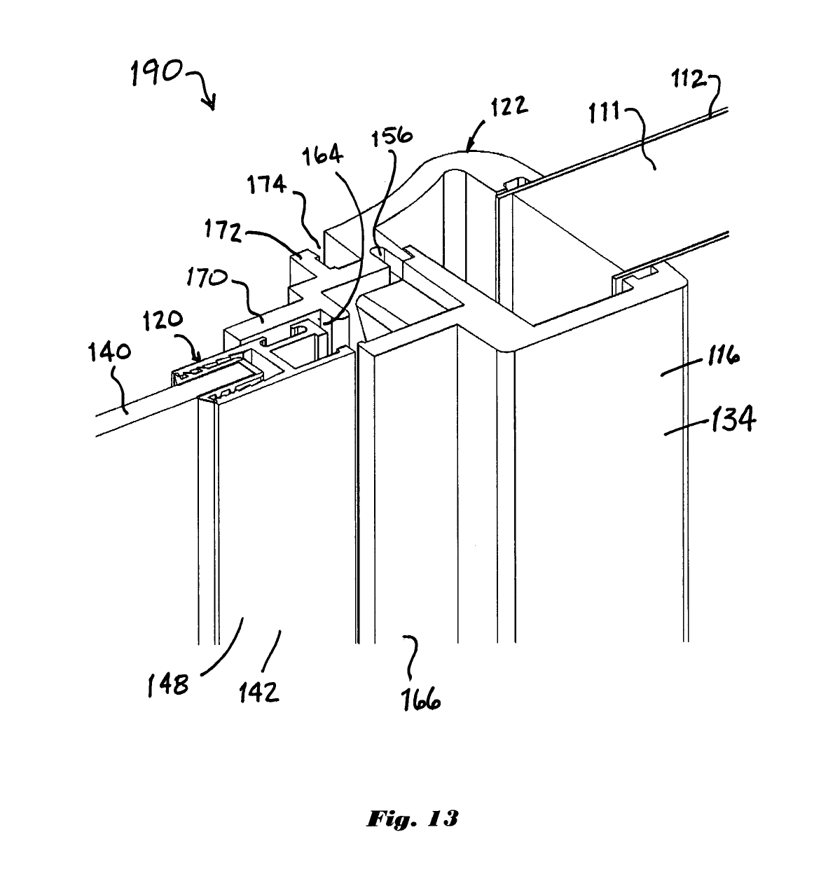

Referring to FIGS. 12 and 13, a window assembly 190 is depicted in another embodiment of the invention. The fixed panel frame 132 includes a second or interior fence portion 192 having an interior face 194 that extends along the ledge 162 on the interior of the fixed panel frame 132. An extension portion 196 may be located between the ledge 162 and the U-shaped channel 174. A gasket or sealant bead 197 may be disposed interstitially between the fixed panel 118 and the fixed panel frame 132. The gasket or sealant bead 197 may be comprised of a marine glazing, a moisture cure or hot melt silicone, a butyl or polyurethane gasket, adhesive backed foam, glazing tapes, or other sealing means that are or become available in the art. Also, the fixed panel 118 may include a U-shaped edging 199 made from a compliant or resilient material such as a flexible PVC.

The presence of the interior fence portion 192 shifts the movable panel 120 inward relative to the position of the fixed panel 118. The sides of the window assembly 190 may be tailored as depicted in FIG. 13 to accommodate the shift, wherein the thickness of the leg 170 on the exterior frame 122 is increased in thickness, and the position of the leg 166 extending from the interior frame 116 is located further inward.

In operation, the top 144 of the movable panel frame 142 is positioned adjacent the interior face 194 of the interior fence portion 192 to provide closure between the fixed panel 118 and the movable panel 120 when in the closed position. The interior fence portion 192 also captures the lower edge of the fixed panel 118. The interior fence portion 192 may be shorter (i.e. extend to a lesser height) than the flange 170, in which case the top 144 of the movable panel frame 142 may register at a lower elevation than with assemblies where the top 144 provides closure directly against the fixed panel 118. For such a configuration, the extension portion 196 conceals the top 144 of the movable panel frame 142 from exterior view. The increased thickness of the leg 170 and revised location of the leg 166 (FIG. 13) combine to move the movable panel channel 164 inward (i.e. closer to the interior face 134), thereby aligning the movable panel 120 for closure with the interior face 194 of the interior fence portion 192.

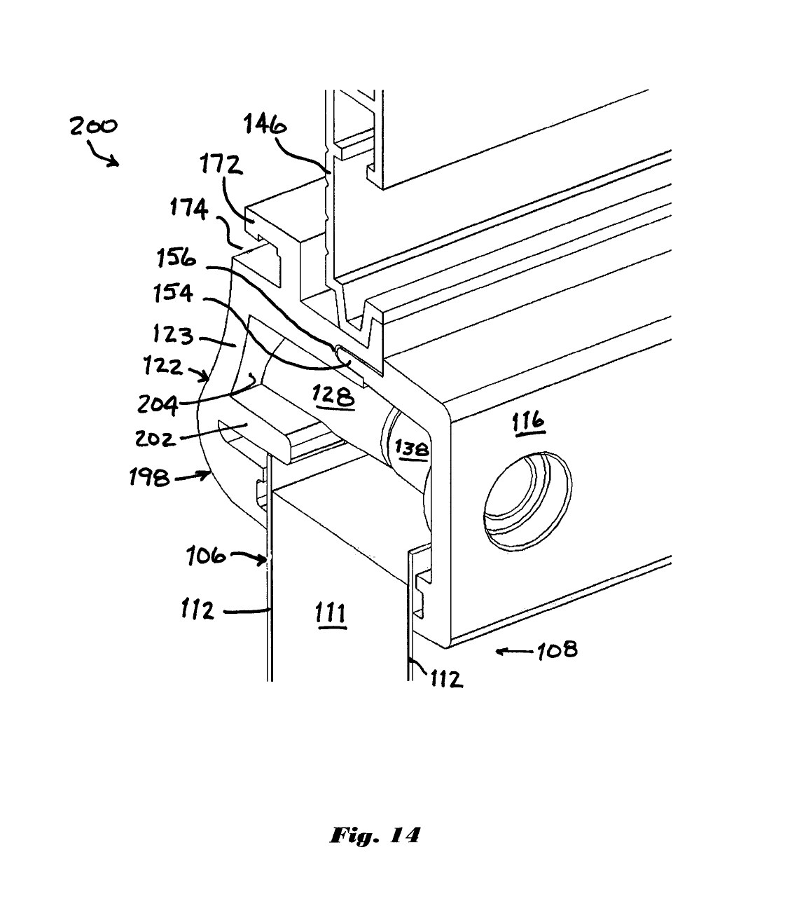

Referring to FIG. 14, a configuration of a bottom portion 198 for a frame assembly 200 is portrayed. In this embodiment, a cantilevered support member 202 extends from an interior surface 204 of the exterior frame 122. The cantilevered support member 202 registers the bottom portion 198 of the frame assembly 202 on the cladding 112. For doors that do not have a cladding, or where the core 111 extends above the cladding 112, the cantilevered support member 202 may rest directly on the core 111 (not depicted). The cantilevered support member concept may extend instead from the interior frame 116 (not depicted), or be utilized on both the interior frame 116 and the exterior frame 122 (not depicted).

The cantilevered portion 202 functions as a registration surface that spreads the weight of the window assembly 104 over a longer line of contact, unlike other embodiments where the weight is supported on the bosses 128, 138 (e.g. FIG. 4). The spreading of the weight reduces attendant stress on the frames 116, 122 and on the cladding 112, and also improves the durability of the frame assembly 200. Also, the cantilevered design will flex under impact loads, such as when the movable panel 120 is dropped into place, thereby serving as a shock absorbing mechanism.

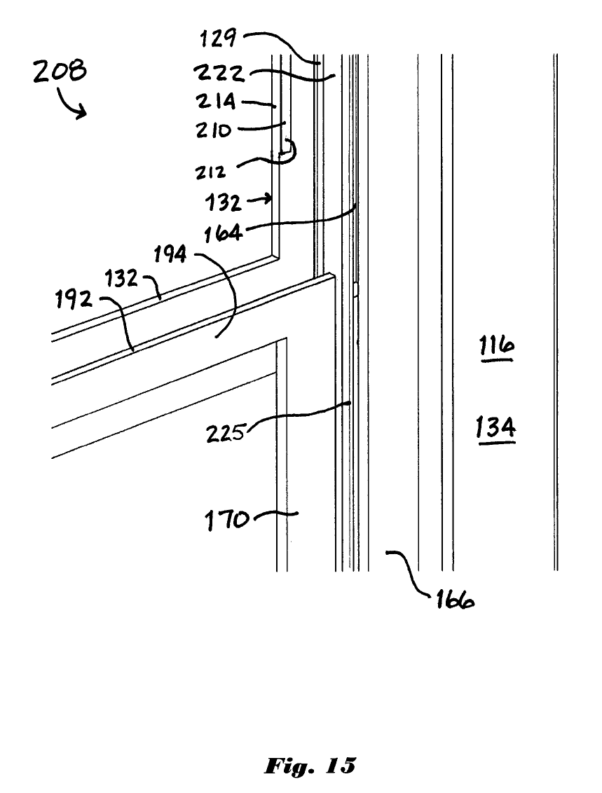

Referring to FIG. 15, an embodiment of a window assembly 208 is depicted wherein a ridge 210 having a mounting face 212 extends at least partially along an inner peripheral edge 214 of the fixed panel frame 132. The fixed panel 118 (not depicted in FIG. 15) may be adhered to the fixed panel frame 132 so that the fixed panel 118 registers against the mounting face 212 of the ridge 210. The FIG. 15 depiction also represents leg 170 as having an increased thickness to bring it flush with the interior face 194 of the interior fence portion 192.

Functionally, the ridge 210 provides a registration that removes the variability that the thickness of the sealant can cause on the location of the fixed panel 118 relative to the movable panel channel 164. Instead, the position of the fixed panel 118 is determined by the height of the thickness of the ridge 210. The ridge 210 also serves to retain sealant during the assembly process, preventing it from squeezing out onto the exterior face of the fixed panel. The increased thickness of the leg 170 provides a continuous guiding surface for the movable panel 120.

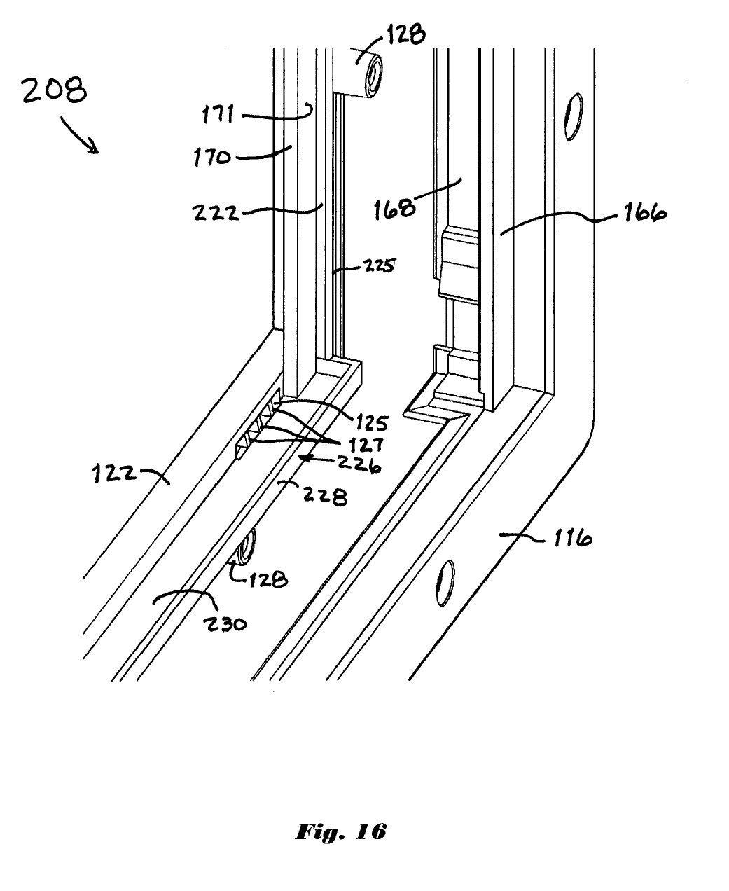

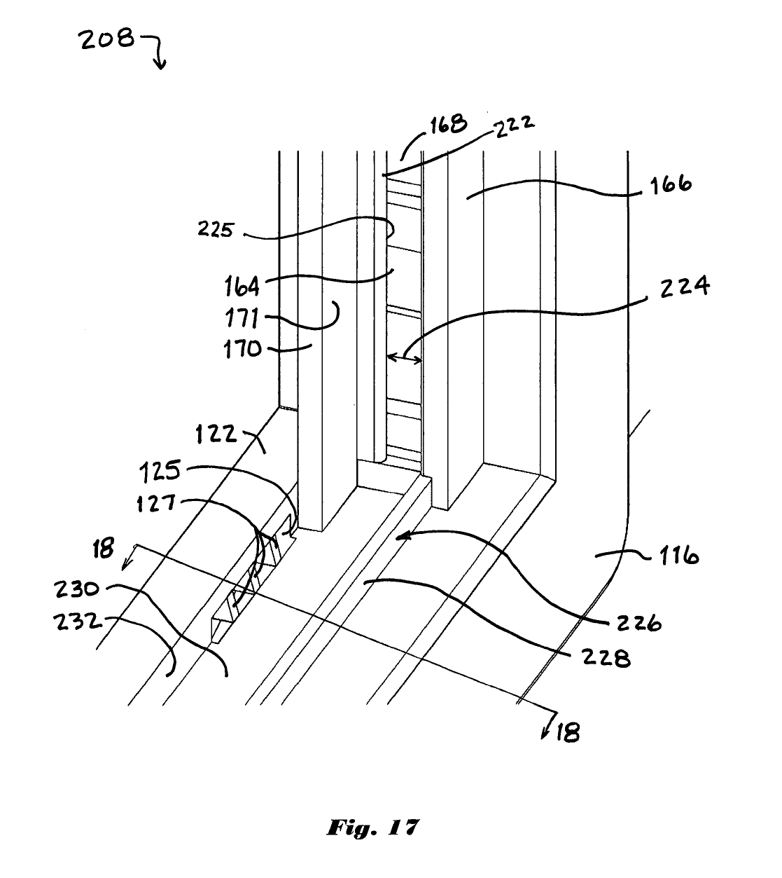

Referring to FIGS. 16 through 18, further depictions of the window assembly 208 are presented in an embodiment of the invention. The window frame assembly 208 includes the movable panel channel 164 defined by the flange or leg 166 and the sidewall or back 168 on the interior frame 116 and the flange or leg 170 on the exterior frame 122. In addition, the exterior frame 170 includes a rib 222 that projects from the interior facing surfaces 171, 129 of legs 170 (FIGS. 16 and 17) and 132 (FIG. 15), respectively. The rib 222 may extend from near the bottom of the legf 170 upward to near the top of the fixed panel frame. A gap 224 is defined between the distal end of the rib 222 and the exterior facing surface 165 on the leg 166 (FIG. 17). Additionally, a second rib (not depicted) may extend from the exterior facing surface 165 in a manner similar to the rib 222.

The rib 222 serves a function similar to the rib portion 131 depicted in FIG. 5. However, by extending along both the interior facing surfaces 171 and 129, the rib 222 provides a continuous bearing surface or line 225 for registration of the movable panel 120 to with respect to the exterior frame 122. The bearing surface or line 225 on the exterior frame 122 provides a continuous bearing surface for both the channel pins 152 and the latches 150 to guide the movable panel 120.

The window assembly 208 also includes a basin 226 that extends from an inner face 232 of the exterior frame 122. The basin 226 is comprised of a side partition 228 disposed on or near three edges of a base portion 230, both the side partition 228 and the base portion 230 extending from the inner face 232 of the exterior frame 122. The basin is in fluid communication with the drainage port 125. The basin 226 may be integrally formed with the interior frame 122. Alternatively, portions of the basin 226 may be formed separately and assembled using attachment means available to the artisan, such as gluing or bonding. The basin 226 may be formed and dimensioned to cooperate with the bottom 146 of the movable panel frame 142 (shown in phantom in FIG. 18).

Functionally, the basin 226 captures moisture such as condensation or precipitation that sheds off the exterior face of the movable panel 120 and directs the moisture to the drainage port 125. Attaching or forming the basin 226 with the exterior frame 122 eliminates potential leakage paths that may otherwise exist between the interior frame 116 and the exterior frame 122. The cooperation between bottom 146 of the movable panel frame 142 and the basin 226 may form a substantially weather tight closure for the window assembly 208.

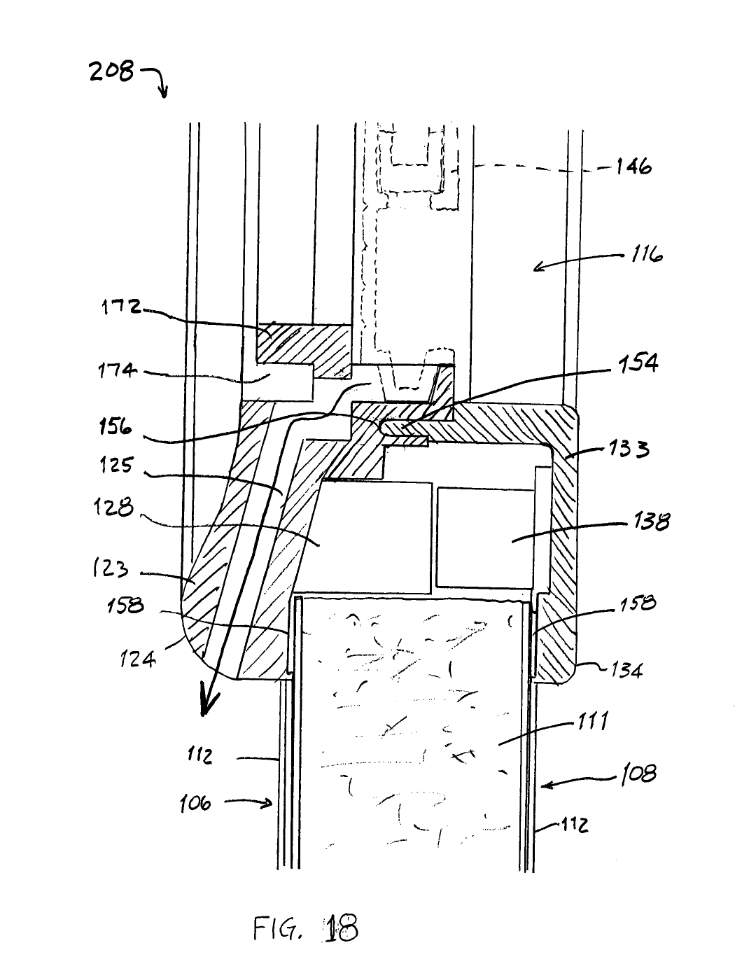

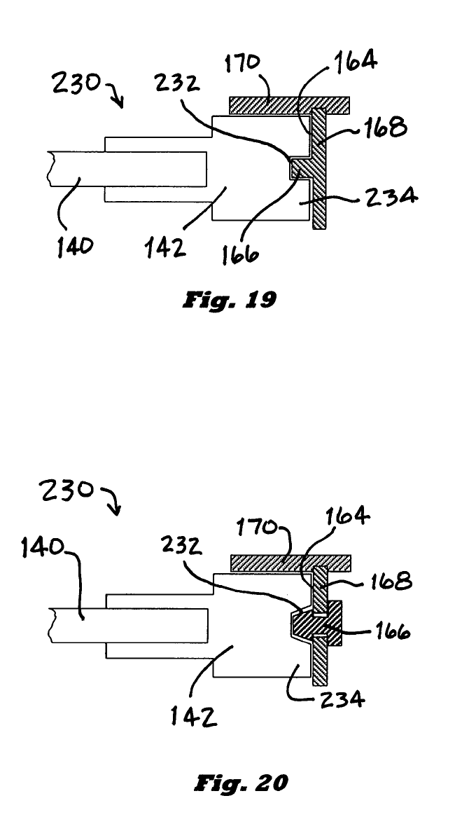

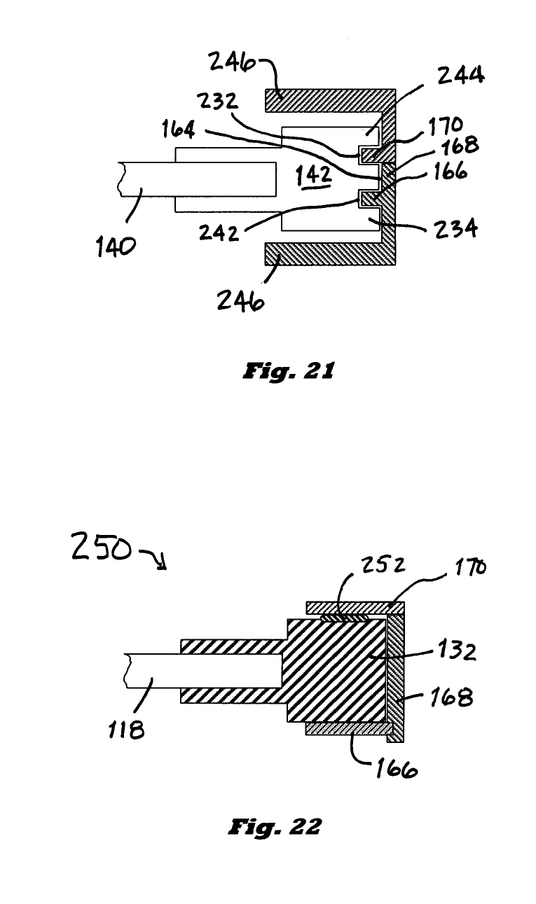

Referring to FIGS. 19 and 20, a window assembly 230 is depicted wherein the leg 166 of the interior frame 116 extends into the movable panel frame 142. In this embodiment, the leg 166 and wall 168 on the interior frame 116 again cooperates with the leg 170 on the exterior frame to form the movable panel channel 164. A slot 232 is formed on the movable panel frame 142 that captures the leg 166 of the interior frame 116 in assembly. An interior portion 234 of the movable panel frame 142 rides outside the movable panel channel 164. The embodiment depicted in FIG. 21 includes a separately formed leg 166 that is snappingly engaged to cooperate with the slot 232.

Referring to FIG. 21, a window assembly 240 is portrayed wherein both the leg 166 on the interior frame 116 and the leg 170 on the exterior frame 122 extend into the movable panel frame 142, which in combination with the wall 168 forms the movable panel channel 164. In this embodiment, the leg 166 and wall 168 on the interior frame 116 again cooperates with the leg 170 on the exterior frame to form the movable panel channel 164. A second slot 242 is formed on the movable panel frame 142 that captures the leg 170 of the exterior frame 122 when the window assembly 240 is assembled. In addition to the interior portion 234, an exterior portion 244 of the movable panel frame 142 rides outside the movable panel channel 164. A bounding frame 246 that extends over the interior or exterior face of the movable panel frame 142 may be formed on the interior frame 116 or the exterior frame 122 or both.

In operation, at least one of the legs 166, 170 of the window assemblies 230 and 240 functions as a rail. The cooperation of either leg 166 or 170 with the corresponding slot 232, 242 enables the movable panel frame 142 to move in parallel with the legs 166, 170. Either of the legs 166, 170 in cooperation with either of the slots 232, 242 may be sufficient to retain the window assembly 120 within the window assembly 230 or 240. The snapping engagement of the leg 166 in the window assembly 236 enables the leg 166 to be assembled after placement of the movable panel 120 for an easier assembly. When utilized, the bounding frame 246, may further facilitate retention of the movable panel frame 142 in the window assemblies 230 or 240. Additionally, the bounding frame may be included to facilitate weather proofing of the window assemblies 230 or 240, or serve an aesthetic purpose.

Referring to FIG. 22, a replaceable fixed panel window assembly 250 is depicted in an embodiment of the invention. The wall 168 and the leg 166 of the interior frame 116 are not integrally formed. Instead, the leg 166 is assembled on the wall 168 after formation. The leg 166 may be removably attached to the wall 168 or otherwise to the interior frame 116. A gasket seal 252 may be included between the fixed panel frame 132 and the leg 170 of the exterior frame 122 (depicted) or between the fixed panel frame 132 and the interior frame 116 (not depicted) or at both locations.

In operation, the removability of the leg 166 enables the fixed panel frame 132 to be removed from the fixed window assembly 250 and replaced, thereby providing a reconfigurable fixed window assembly that has all of the manufacturing assembly advantages of the split interior/exterior frame assembly. In certain embodiments, the fixed panel assembly 250 may provide a “full view door” wherein the fixed panel 118 is the only panel in the window assembly 250 (i.e. no second or movable panel) and extends over one large opening of the storm door. The fixed panel 118 and fixed panel frame 132 may comprise a screen in the summer months and be replaced with a glass pane in the winter months.

The embodiments above are intended to be illustrative and not limiting. Additional embodiments are within the claims. For example, the door assembly as depicted and described herein can be used as a door in a recreational vehicle (“RV”) or any other residence or building including an entryway. Furthermore, the various window assemblies described herein may be suitable for use on structures other than doors, such as window openings on the panels or walls of trailers, fish houses, or other enclosures. The split frame concept for the window assembly disclosed herein may also be applicable to window installations on buildings. Although the invention has been described with reference to particular embodiments, workers skilled in the art will recognize that changes can be made in form and detail without departing from the spirit and scope of the invention.

What is claimed is:

1. A window assembly comprising:
a first frame operably coupled to a second frame, the first frame including an outwardly extending flange having an exterior face and an opposed interior face, the first frame and the second frame cooperating to define a channel therebetween;
a movable panel operably coupled with the channel;
a drainage port formed through the outwardly extending flange; and
a basin in fluid communication with the drainage port.

2. The door assembly of claim 1 wherein the basin extends from an inner face of the second window frame.

3. The door assembly of claim 1 wherein the basin extends from an inner face of the first window frame.

4. A window assembly comprising:
a first frame operably coupled to a unitary second frame to present a channel for guiding a selectively movable panel, the first frame being a unitary component including four linear members that define a first rectangular opening therethrough, the second frame being a unitary component including four linear members that define a second rectangular opening therethrough, the channel being defined by and between a leg and a wall on the first frame and a leg on the second frame, at least a portion of the leg of the second frame extending substantially parallel to the leg of the first frame, the wall extending substantially perpendicular to the leg of the first frame;
a drainage port defined in one of the first frame and the second frame;
a basin in fluid communication with the drainage port;
a lip formed on at least a portion of one of the first frame and the second frame; and
a recess formed on the other of the first frame and the second frame,
wherein the lip extends substantially parallel to the wall of the first frame and is positioned within the recess for alignment of the first frame with the second frame.

5. The window assembly of claim 4 wherein the basin extends from an inner face of one of the first frame and the second frame, and wherein the drainage port is formed in the same one of the first frame and the second frame.

6. A door assembly comprising:
a door panel including an interior face, an exterior face opposite the interior face, and an opening defined through the interior face and exterior face;
a first window frame operably coupled about the opening and to a second window frame, such that a surface of the first window frame contacts one of the interior face and the exterior face of the door panel and a surface of the second window frame contacts the other one of the interior face and the exterior face of the door panel;
structure defining a drainage opening that extends through one of the first window frame and the second window frame;
a basin integral with one of the first window frame and the second window frame, the basin being in fluid communication with the drainage opening; and
a movable panel operably coupled to a channel for guiding the movable panel, the channel being defined by a leg and a wall on the first window frame and a leg on the second window frame, the leg of the first window frame extending in a direction substantially parallel to the movable panel, the wall extending perpendicular to the leg of the first window frame, and the leg of the second window frame extending parallel to the leg of the first window frame.

7. The door assembly of claim 6, further comprising a window screen operably coupled between the first window frame and the second window frame.

8. The door assembly of claim 6, wherein the door panel is comprised of a cladded interior core.
